(19) United States
(12) Patent Application Publication
(10) Pub. No.: US 2015/0153535 A1
(43) Pub. Date: Jun. 4, 2015

(54) COLOR VALUE TOOL AND METHOD

(71) Applicant: Joleene Kooyman, Logan, UT (US)

(72) Inventor: Joleene Kooyman, Logan, UT (US)

(21) Appl. No.: 14/093,289

(22) Filed: Nov. 29, 2013

(51) Int. Cl. G02B 7/00; G02C 7/10; G02B 5/22

(52) U.S. Cl. CPC G02B 7/006; G02B 5/22; G02C 7/104

(57) ABSTRACT

A hands free color value tool that can be used by a designer to determine the desired contrast in their design, which will lead to a better and more memorable design.

### FIELD OF THE INVENTION

The present invention relates generally to eyeglasses containing an optical filter that allows the user to better see the color values among selected materials.

### BACKGROUND OF THE INVENTION

One of the most important steps in designing a quilt, article of clothing or flower arrangement is to pick out materials that have the proper color value. Typically, a person designing a quilt, article of clothing or flower arrangement will pick out several items, line them up and make a judgment about the color value. Often, this is not completely successful. In order to help with seeing color value and therefore obtaining the proper contrast, it is known to view materials through a value viewer. This is often nothing more than a piece of transparent red plastic. It can be very cumbersome, however, to use a handheld value viewer as it requires a person to use his or her hand to hold the viewer while also trying to arrange their materials. As a result, people do not always use a handheld value viewer because it is simply not user friendly, and the designer ends up not maximizing the contrast of their materials. To date, there have not been color value glasses that allow a quilter, designer, seamstress, fabric artist or florist to use both hands to arrange their materials while at the same time seeing the color value of the materials to achieve the proper contrast for their design.

Because hand held viewers are hard to use, they are not frequently used in the art. Hands free value viewers are not known in the art. Nothing in the prior art provides a single piece hands free tool that can be used to evaluate the color value among materials of various colors.

### SUMMARY OF THE INVENTION

The present invention has been accomplished to provide a hands free color value tool.

According to the present invention, there is provided color value eyeglasses, which are generally comprised of an eyeglass frame and color value lenses.

In one aspect of the invention, it provides a hands free color value tool to permit a user to better identify contrast in color among various materials.

In another aspect of the invention, it provides a method for a quilter, designer, seamstress, fabric artist or florist to easily design a project that has effective contrast.

In another aspect of the invention, it provides a hands free value viewer that can be clipped on to existing glasses.

In another aspect of the invention, it provides a tool that permits the user to have their hands free to manipulate patterns, materials (including bulky materials like bolts of fabric) and colors to determine desired contrast.

To the accomplishment of the above and related aspects, the invention may be embodied in the form illustrated in the accompanying drawings. The drawing, however, is illustrative only. Variations are contemplated as being part of the invention, limited only by the scope of the claims.

### BRIEF DESCRIPTION OF THE DRAWINGS

FIG. 1 shows a perspective view of the color value eyeglasses.

FIG. 2 shows a perspective view of the hands free color value view than can be clipped to existing eyeglasses.

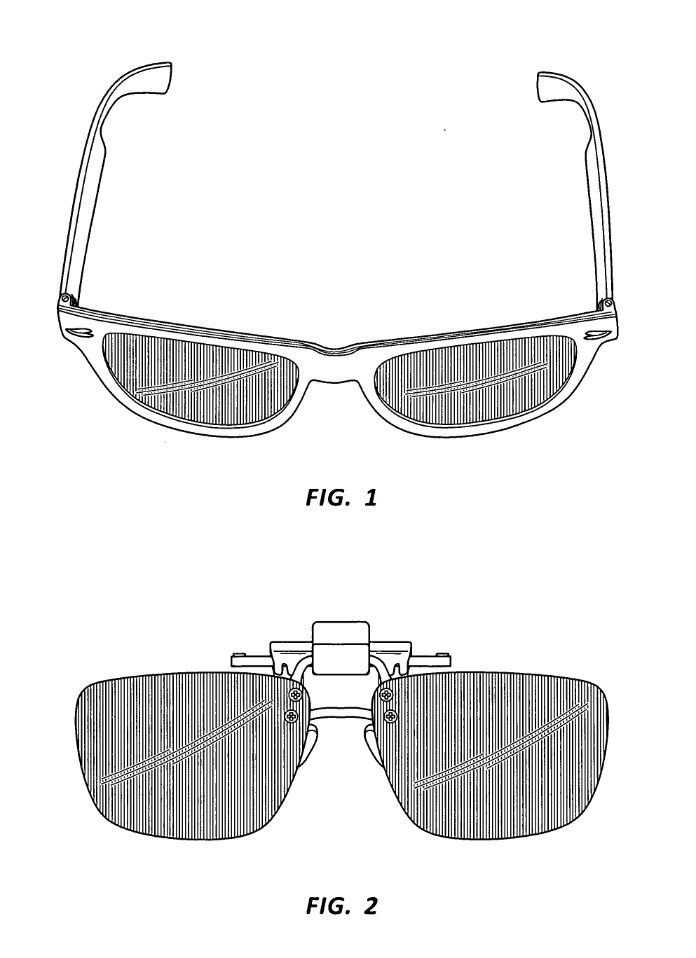

### DETAILED DESCRIPTION OF THE INVENTION

As shown in the accompanying drawing, the present invention is a hands free color value tool. It provides the simplest way to determine the color value of materials of different colors that a person would like to combine. Color value is often more important than color in a design. Color value is what really makes a design stand out, and it is not as simple as simply picking out desired colors. Color value determines how close a color is to either black or white. It is the differences in value that really shows contrast and proper contrast is what makes a design remarkable. Without contrasting values in a design, it will appear flat and dull. Using color value instead of color alone actually removes color from the equation and permits the designer (whether it be for a quilt, a fashion design or a floral arrangement) to view the materials in grayscale. By removing the color, a designer can more easily identify the value of a fabric or flower. Dark color values stand out and light values fade into the background of a design. In the past, designers have used value finders that they hold in their hand in front of their eyes or took pieces of materials and copied them on a black and white copy machine. Both of these manners are too cumbersome and time consuming. The present invention allows a designer to gather the materials they want to use in their design, place them in front of them, put on the color value eyeglasses, and then manipulate the location of the materials relative to each other to get the proper contrast, which results in a unique and memorable design. In the preferred embodiment, the color of the lens in the color value eyeglasses is red, but other lens colors, such as green, can also be utilized.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

I claim:

1. A hands free color value tool comprising:
an eyeglass frame; and
color value lenses.

2. The hands free color value tool of claim 1 wherein the color value lenses are red.

3. The hands free color value tool of claim 1 wherein the color value lenses are green.

4. A method for determining the color values of a design comprising the steps of:
selecting the materials for the design;
determining the focal material of the design;
putting on color value eyeglasses to view the design materials in grayscale;
picking out materials that are complimentary to the focal material; and
organizing the materials according to color value: dark, medium and light.

5. A hands free color value tool comprising:
A clip on eyeglass frame; and
color value lenses.
